(19) United States
(12) Patent Application Publication
(10) Pub. No.: US 2013/0182415 A1
(43) Pub. Date: Jul. 18, 2013

(54) METHODS FOR FORMING CONTOURED PORTIONS OF LIGHTING FIXTURES AND LIGHTING FIXTURES INCORPORATING SAME

(71) Applicant: Roslyn J. YANDO, Brainardsville, NY (US)

(72) Inventor: Roslyn J. YANDO, Brainardsville, NY (US)

(21) Appl. No.: 13/352,917

(22) Filed: Jan. 18, 2012

(51) Int. Cl. F21V 21/00; A41G 1/00; B23P 11/02

(52) U.S. Cl. 362/122; 362/249.01; 29/446; 428/17

(57) ABSTRACT

A method for forming a lighting fixture includes obtaining at least one bendable member having a plurality of spaced-apart portions which define a generally planar configuration, bending by hand the at least one bendable member so that the spaced-apart portions define a non-planar surface, and operably connecting the at least one bent member to at least one of a light source or to an electrical receptacle for receiving a light bulb for illuminating the bent member. The bendable member may be configured as an ornamental vine having at least one elongated stem and a plurality of leaves extending from said at least one elongated stem, and a plurality of decorative elements attached to at least some of said leaves and to said stem.

### CROSS-REFERENCE TO RELATED APPLICATIONS

This application is related to commonly assigned, co-pending design Pat. application Serial No. 29/411,226, filed Jan. 18, 2012, entitled “Chandelier” (Atty. Dock. No. 2350.396), the entire application of which is hereby incorporated herein by reference.

### FIELD OF THE INVENTION

The present invention relates generally to lighting fixtures, and more specifically to methods for forming contoured portions of lighting fixtures and lighting fixtures incorporating same.

### BACKGROUND OF THE INVENTION

Chandeliers are typically formed of frame members from which a plurality of crystal or glass ornaments suspended to provide an overall decorative appearance. The ornaments are typically attached to a metal wire having a hook at one end that passes loosely through a hole in the crystal and a hook at the other end that passes through a hole in the chandelier framework. In such an arrangement, the ornaments are supported solely by the wire and hang below the frame member.

U.S. Pat. No. 5,577,838 issued to Lucas discloses a chandelier frame having a first frame member and a second frame member that are connected by a plurality of arms at joints. The joints are plastically and asymmetrically deformed to locate each of the frame members in axially remote planes. In another embodiment, a first and second frame member having arms therebetween are rotated from a first plane defined by the frame members into a second plane that is substantially transverse to the first plane. The arms are joined to a locking structure that enables the first and second frame members to be maintained in an elastically deformed shape defining a bowl-like shape. In another embodiment, a frame member is held in an elastically deformed, stressed state by an arm interconnected with interengaging locking structures on the arm.

U.S. Pat. No. 7,101,065 issued to Buyer discloses arrangements and methods for mounting decorative ornaments and fixtures having decorative ornaments. The decorative ornaments may be, for example, beads, crystals, or gems. The arrangement including a frame having an aperture and the aperture having an internal surface, and at least one ornament mounting post projecting from the frame, wherein the ornament is retained by the mounting post and the internal surface of the aperture when the ornament is mounted on the mounting post.

There is a need for methods for forming contoured portions of lighting fixtures and lighting fixtures incorporating same.

### SUMMARY OF THE INVENTION

In a first aspect, the present invention provides a method for forming a lighting fixture. The method includes obtaining at least one bendable member having a plurality of spaced-apart portions which define a generally planar configuration, bending by hand the at least one bendable member so that the spaced-apart portions define a non-planar surface, and operably connecting the at least one bent member to at least one of a light source or to an electrical receptacle for receiving a light bulb for illuminating the bent member.

In a second aspect, the present invention provides a lighting fixture which includes at least one bent member having a plurality of spaced-apart portions defining a non-planar surface, the at least one bent member formed by hand from a member having a plurality of spaced-apart portions defining a planar configuration, and at least one light source or electrical receptacle for receiving a light bulb for illuminating the at least one bent member.

In a third aspect, the present invention provides an ornamental vine for a lighting fixture. The ornamental vine includes at least one elongated stem and a plurality of leaves extending from the at least one elongated stem, and a plurality of decorative elements attached to at least some of the leaves and to the stem.

In a fourth aspect, the present invention provides a lighting fixture which includes a plurality of the above-noted ornamental vines, and at least one light source or electrical receptacle for receiving a light bulb for illuminating the plurality of ornamental vines.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a front side elevational view of a lighting fixture configured as a chandelier in accordance with aspects of the present invention;

FIG. 2 is a front side elevational view, portions cutaway, of the lighting fixture of FIG. 1;

FIG. 3 is an enlarged plan view of one of the ornamental vines of FIG. 1 in accordance with aspects of the present invention;

FIG. 4 is a side elevational view of one of the decorative elements of the ornamental vine of FIG. 3;

FIG. 5 is an enlarged view of a portion of the ornamental vine of FIG. 3;

FIG. 6 is a side elevational view of another one of the decorative elements of the ornamental vine of FIG. 3;

FIG. 7 is a view taken along line 7-7 in FIG. 5;

FIG. 8 is an enlarged plan view of another of the ornamental vines of FIG. 1 in accordance with aspects of the present invention;

FIG. 9 is an enlarged view of a portion of the ornamental vine of FIG. 8;

FIG. 10 is a bottom view of the lighting fixture of FIG. 1;

FIG. 11 is a side elevational view of another embodiment of a portion of a lighting fixture in accordance with aspects of the present invention; and

FIG. 12 is a flowchart of a method for forming a portion of a lighting fixture in accordance with aspects of the present invention.

### DETAILED DESCRIPTION OF THE INVENTION

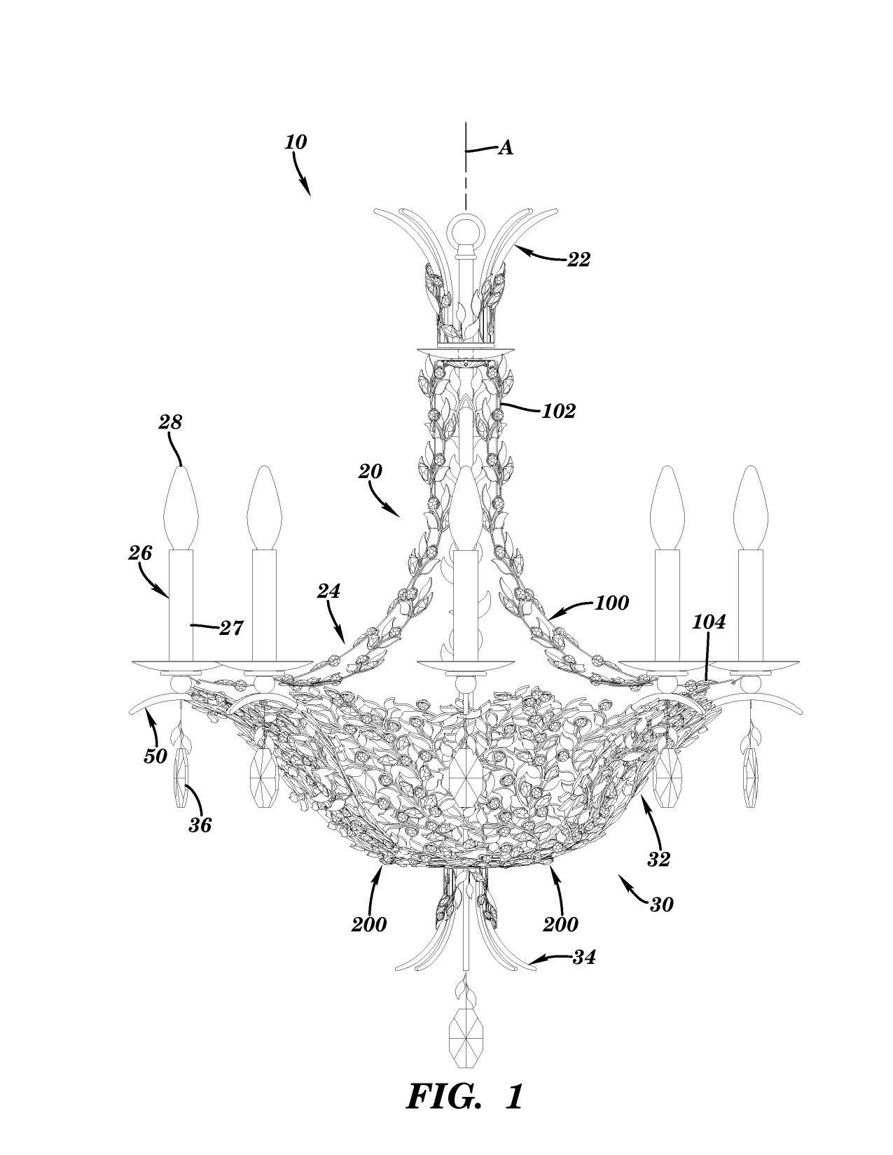

FIG. 1 illustrates one embodiment of a lighting fixture 10 in accordance with aspects of the present invention in which the lighting fixture may be configured as a chandelier. In this illustrated embodiment, lighting fixture 10 may include an upper portion 20 and a lower portion 30. Upper portion 20 may generally include an upper finial or crown sector 22, a plurality of chains 24, and a plurality of light sources 26. The light sources may include a candle shaped light source comprising a candle 27 and a light bulb 28. Lower portion 30 may generally include a basket 32 and lower finial 34. While the illustrated lighting fixture may include eight candle shaped light sources disposed around the lighting fixture, it will be appreciated that the lighting fixture may be configured with more or less that eight candle shaped light sources.

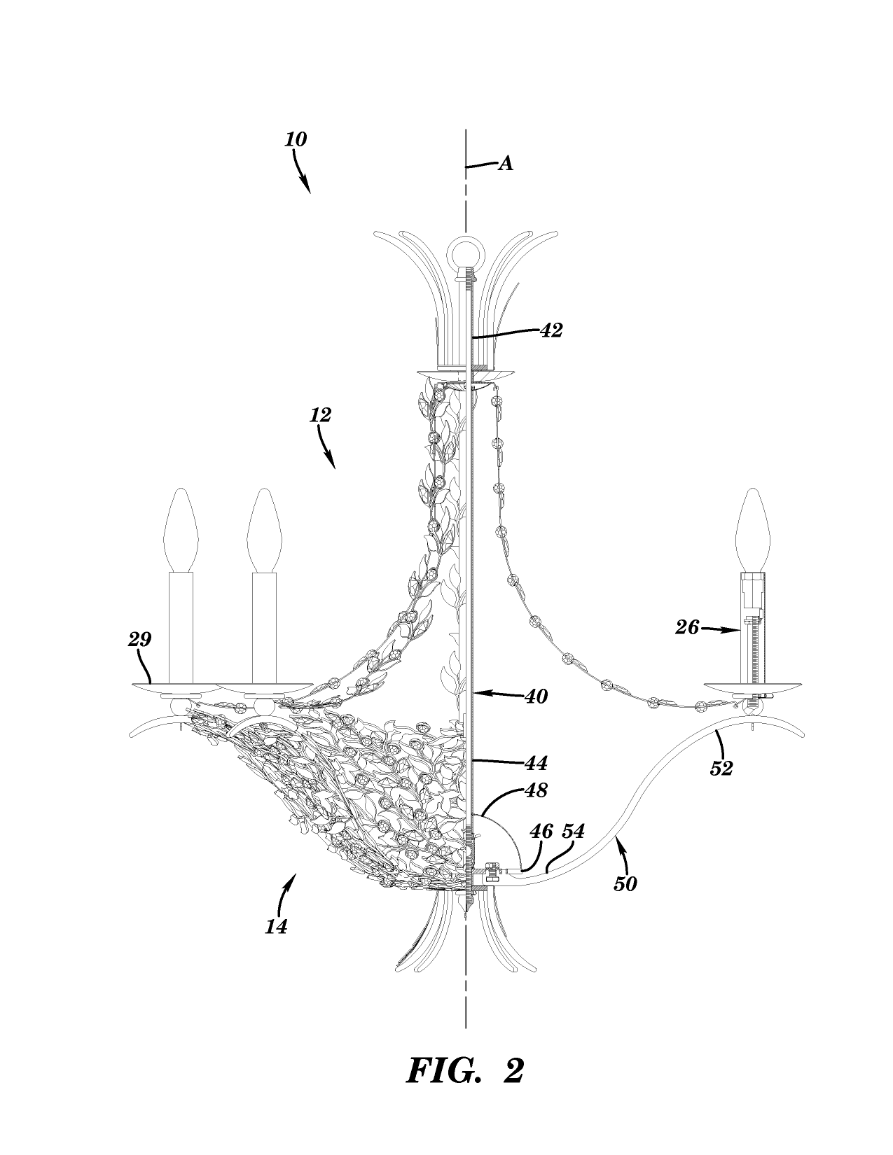

As shown in FIG. 2, lighting fixture 10 may include a column or center support 40 having an upper end portion 42 and a lower end portion 44. A bottom center plate 46 may be operably connected to lower portion 44 of central support 40. A plurality of arms 50 may extend radially outwardly from center plate 46 and support lighting sources 26 such as the candle lights and/or other features. For example, a distal end portions 52 of arm 50 may support the lighting source, and a proximal end portion 54 may operably attach to center plate 46. The bottom center plate may be a plate, a disc, a ring, or any other suitable connection member. In some embodiments, a cover 48 may be placed over or around the center plate to obscure the center plate from view. Bobeches 29 or other cup decorations surround the base of the candle lights. The bobeches and other decorative pieces are not required, and may be of any suitable shape or configuration if present. As shown in FIG. 1, crystals 36 may be suspended by a wire from arms 50.

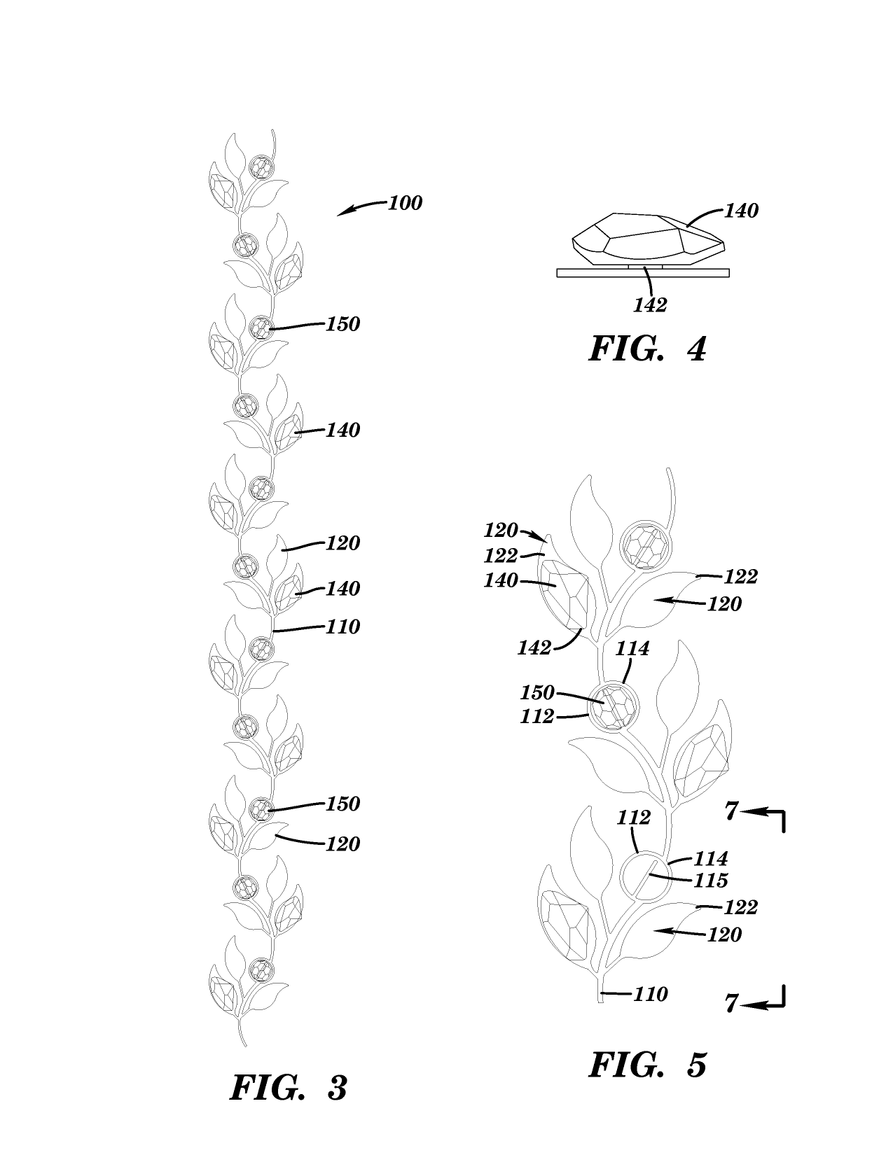

FIG. 3 illustrates one embodiment of an ornamental vine 100 in accordance with aspects of the present invention for use as chains 24 in lighting fixture 10 (FIG. 1). For example, as described in greater detail below, ornament vine 100 may be initially formed from a planar member and then formed by hand to have a contour such as being curved and spanning between its opposite ends as shown in lighting fixture 10 (FIG. 1).

In this illustrated embodiment, ornamental vine 100 includes an elongated stem 110 and a plurality of leaves 120 which extend from elongated stem 110. A plurality of decorative elements 140 and 150 are attached to at least some of leaves 120 and to elongated stem 110. Decorative elements 140 may have a generally flat back which is operably attached to a generally flat front side of leaves 120. For example, as shown in FIG. 4, a double sided adhesive foam disc 142 may be employed to attach the backs of the decorative elements to the front of the leaves. With reference to FIG. 5, leaves 120 includes a peripheral edge 122, and decorative elements 140 includes a peripheral edge 142 which generally corresponds to peripheral edge 122 of leaf 122 to which it is attached. While the leaves and decorative elements are shown to have about the same size and shape, it will be appreciated that the ornamental vine may have leaves and decorative elements having a plurality of different sizes and shapes, and may have the same or different colors.

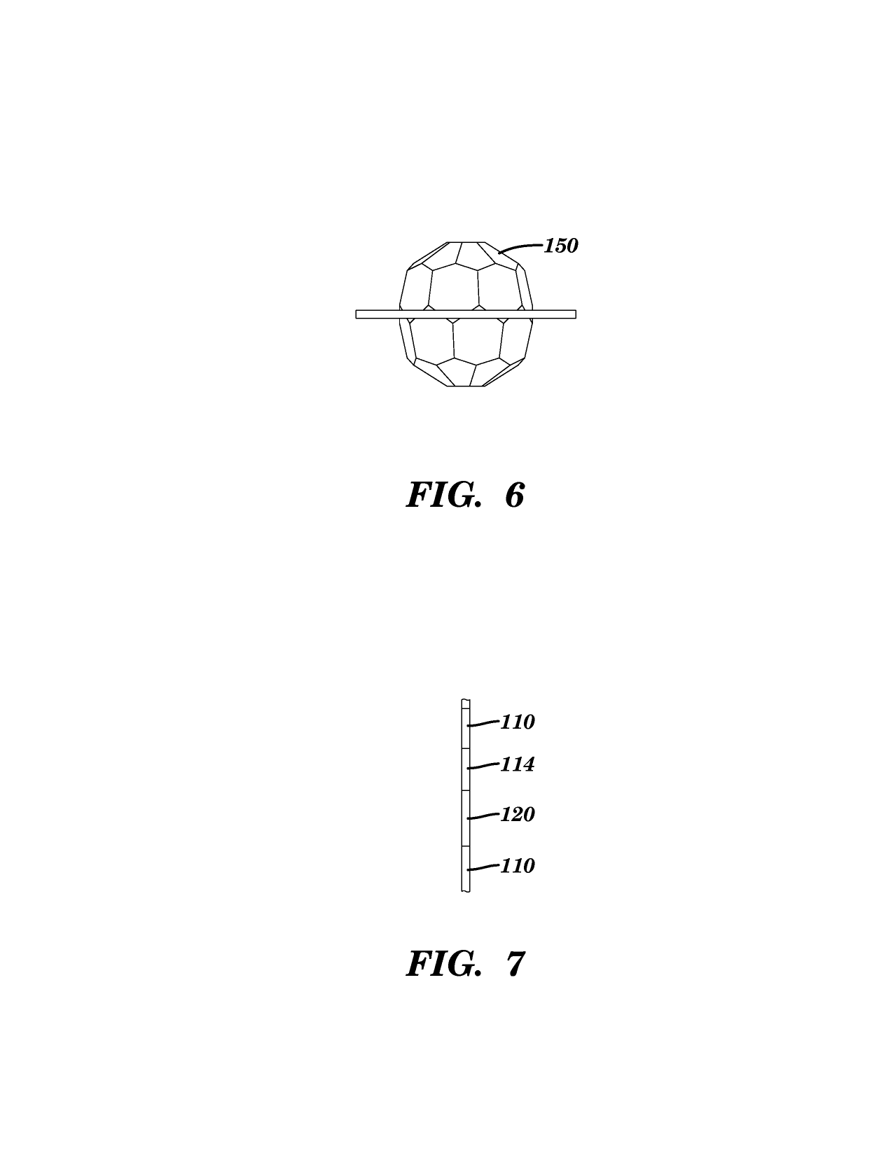

With reference still to FIG. 5, elongated stem 110 may comprise a portion of elongated stem 110 that divides into at least two portions 112 and 114. A decorative element 150 may be disposed between divided portions 112 and 114. For example, elongated stem 110 may include a post 115 extending between divided portions 112 and 114 of elongated stem 110 for supporting decorative element 150. One end of post 115 may be attached to stem 110, and the other end of post 115 may be spaced from stem 110 and divided portions 112 and 114. The divided portions 112 and 114 may form a circle around decorative element 150. As shown in FIGS. 5 and 6, decorative element 150 may have a generally spherical shape having a hole or passageway therein which receives post 115 (FIG. 5). Post 115 may be bent out of the plane of divided portions 112 and 114, decorative element 150 placed on post 115, and then decorative element 150 and post 115 rotated and bent back so that post 115 aligns with divided portions 112 and 114.

As best shown in FIG. 7, elongated stem 110, leaves 120, divided portions 112 and 115, and post 115 may be formed from a flat planar member. For example, the elongated stem, the leaves, the divided portions, and the post maybe laser cut from a flat planar member. As described below, the planar material may be formed from a bendable material which allows one to bend by hand the ornamental vine so that the ornamental vine has a contoured configuration without the need for use of dies, molds, jigs, spinning, and/or 3-dimensional laser cutting.

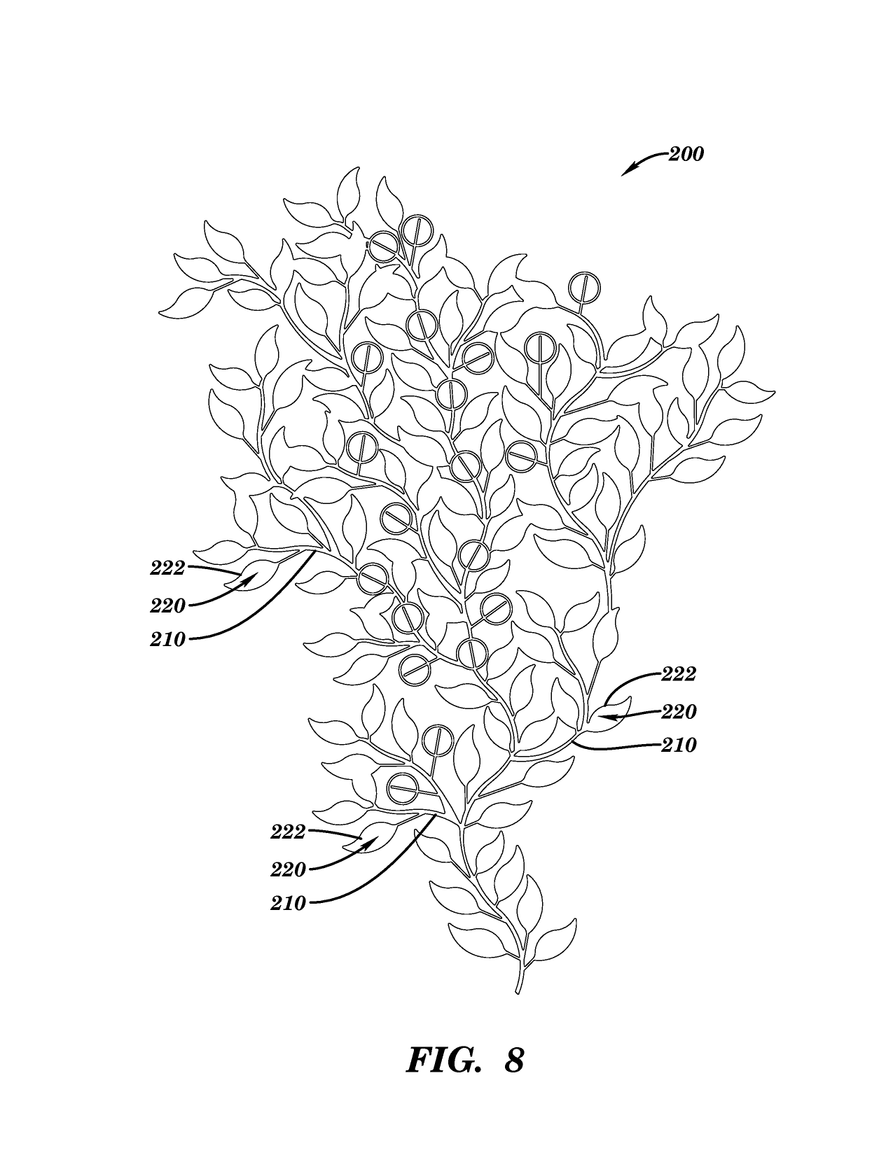

FIG. 8 illustrates another embodiment of an ornamental vine 200 in accordance with aspects of the present invention for use in lighting fixture 10 (FIG. 1). For example, as described in greater detail below, a plurality of ornament vines 200 may be initially formed from one of more planar members and then formed by hand to have a contour such as bowl or basket shaped configuration as shown in lighting fixture 10 (FIG. 1). Decorative elements may be attached to at least some of leaves 220, to elongated stems 210, and to branches 230.

In this illustrated embodiment, ornamental vine 200 includes a plurality of stems 210 and a plurality of leaves 220 which extend from the plurality of elongated stems 210. For example, leaves 220 include a peripheral edge 222, and some of leaves 220 may be attached to decorative elements 140 (FIG. 4) having a peripheral edge which generally corresponds to peripheral edge 222 of leaves 220. Decorative elements 140 (FIG. 4) may have a generally flat back which operably attaches to a generally flat front side of leaves 220. For example, a double sided adhesive foam disc 142 (FIG. 4) may be employed to attach the backs of the decorative elements to the front of the leaves. While leaves 220 and decorative elements 240 may have about the same size and shape, it will be appreciated that the ornamental vine may have leaves and decorative elements having a plurality of different sizes and shapes, and may have the same or different colors

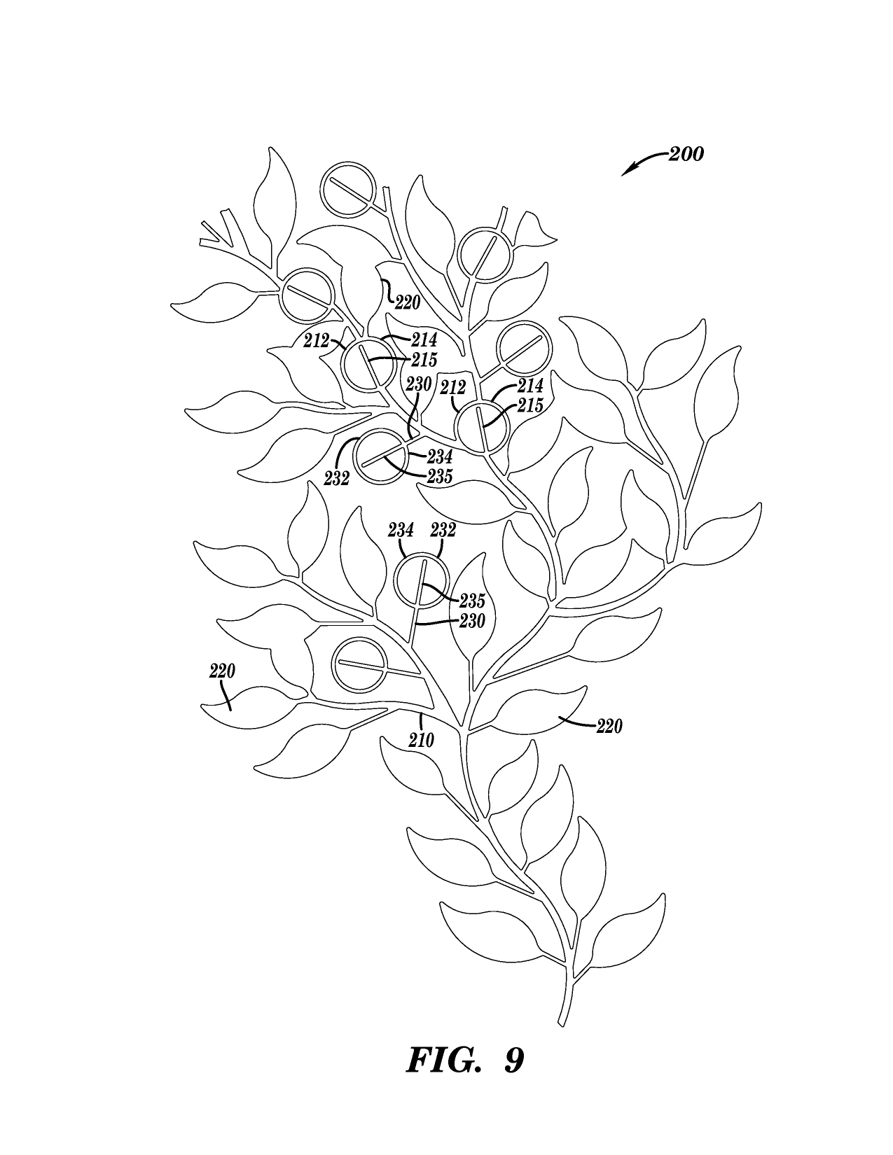

As best shown in FIG. 9, elongated stems 210 may comprise a portion of elongated stem 210 that divides into at least two portions 212 and 214. A post 215 may extend between divided portions 212 and 214 of elongated stem 210. One end of post 215 may be attached to stem 210, and the other end of post 215 may be spaced from stem 210 and divided portions 212 and 214. The divided portions 212 and 214 may form a circle. Decorative elements 150 (FIG. 6) may be disposed between divided portions 212 and 214 of stems 210. For example, decorative elements 150 may be supported on posts 215.

In addition, the plurality of branches 230 may extend from elongated stems 210. Branches 230 may comprise a portion that divides into at least two portions 232 and 234. A post 235 may extend between divided portions 232 and 234 of branches 230. One end of post 235 may be attached to branch 230, and the other end of post 235 may be spaced from divided portions 232 and 234. The divided portions 232 and 234 may form a circle. Decorative elements 150 (FIG. 6) may also be supported on posts 235. Decorative elements 150 may have a generally spherical shape having a hole or passageway therein which receives posts 215 and 235. Post 215 and 235 may be bent out of the plane of their respective divided portions, decorative elements 150 placed on post 215 and 235, and then decorative elements 150 and posts 215 and 235 rotated so that posts 215 and 235 align with their respective divided portions.

Decorative elements 140 may comprises transparent, translucent, or opaque glass, plastic, stone, or precious gems, for example, natural or synthetic gems, such as, diamonds, rubies or sapphires. Suitable decorative elements 140 also include crystals available from D. Swarovski Company of Wattens, Austria. For example, suitable crystals include Swarovski Element Crystal Collection such as Flat Backs which are loose crystal elements with platinum foiling disposed on the back for extra brilliance and protection, and are available in a multitude of colors, shapes and cuts.

Decorative elements 150 may comprises transparent, translucent, or opaque glass, plastic, stone, or precious gems, for example, natural or synthetic gems, such as, diamonds, rubies or sapphire. Suitable decorative elements 150 also include crystals available from D. Swarovski Company of Wattens, Austria.

As also illustrated in FIG. 9, at least one additional stem may extend from the divided portions of elongated stem 210, and leaves 220 may extend from the divided portions of elongated stem 210.

With reference again to FIG. 8, elongated stems 210, leaves 220, divided portions 212 and 235, and posts 215 and 235 may be formed from a flat planar member. For example, the elongated stems, the leaves, the divided portions, and the post maybe laser cut from a flat planar member. As described below, the planar material may be formed from a bendable material which allows one to bend by hand the ornamental vine so that the ornamental vine has a contoured configuration without the need for use of dies, molds, jigs, spinning, and/or 3-dimensional laser cutting.

The bendable material may be a metal material such as steel or other suitable material that may be readily bent by hand while retaining its shape after being bent or formed by hand. For example, the bendable material forming the ornamental vines may be a cold rolled mild carbon steel about 0.036 inch (about 1 mm) thick. Once the bendable material is cut, the elongated stem, leaves, divided portions and posts, it may be painted or powdered coated before attaching the decorative elements.

With reference again to FIG. 1, ornamental vine 100 initially formed from a cut planar member, may be formed by hand to have a contour spanning between an end portion 102 operably attached to support 40, and an end 104 operably attached to the distal end of arm 50.

A plurality of ornamental vines 200 (FIG. 8) initially formed from one or more cut planar members, may form a plurality of generally triangular shaped segments which are assembled into basket 32. For example, ornamental vine 200 may be formed by hand to have a contour so that the leaves along the edges of ornamental vine 200 are disposed against curved shaped arms 50. The leaves disposed against arms 50 may be operably attached to the arms, for example, by tack welding. The edges of the ornamental vine segments may overlap each other and attach to the arms.

The formed ornamental vines 200 may result in the basket as having a generally smooth contoured surface or configuration, having a contour in at least two directions, and/or having a contour in an X direction, a Y direction, and a Z direction.

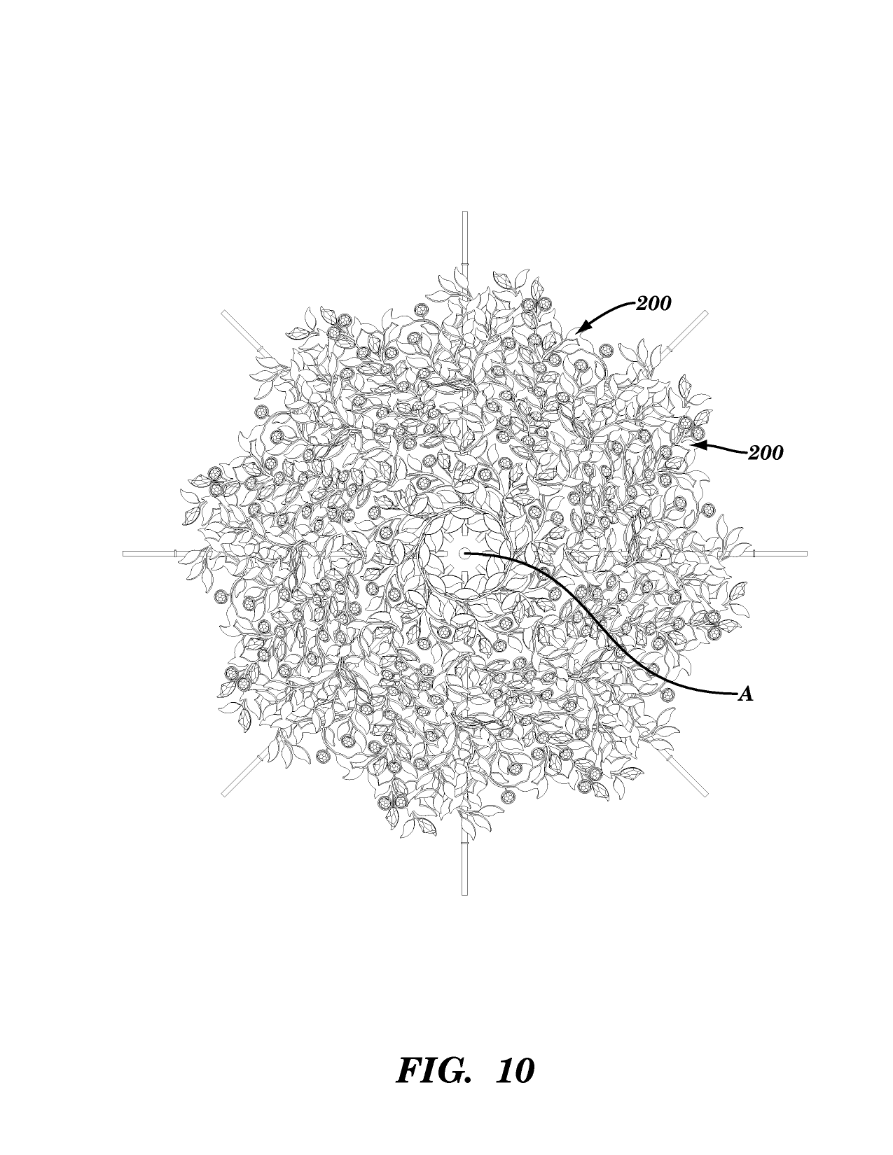

With reference to FIGS. 1 and 10, the plurality of stems and/or decorative elements of ornamental vine 200 may be disposed on an angle relative to axis A. This provides the appearance that the ornamental vines are twisting, spiraling, or angling around the axis of the light fixture. Similarly, the upper ends of the ornamental vine 100 (FIG. 10) may not be in vertical alignment with the arms, and instead the upper ends of ornaments vine 100 may be shifted relative to the respective arm to which the ornamental vine is attached to provide the appearance that the ornamental vines are twisting, spiraling, or angling around the axis of the lighting fixture.

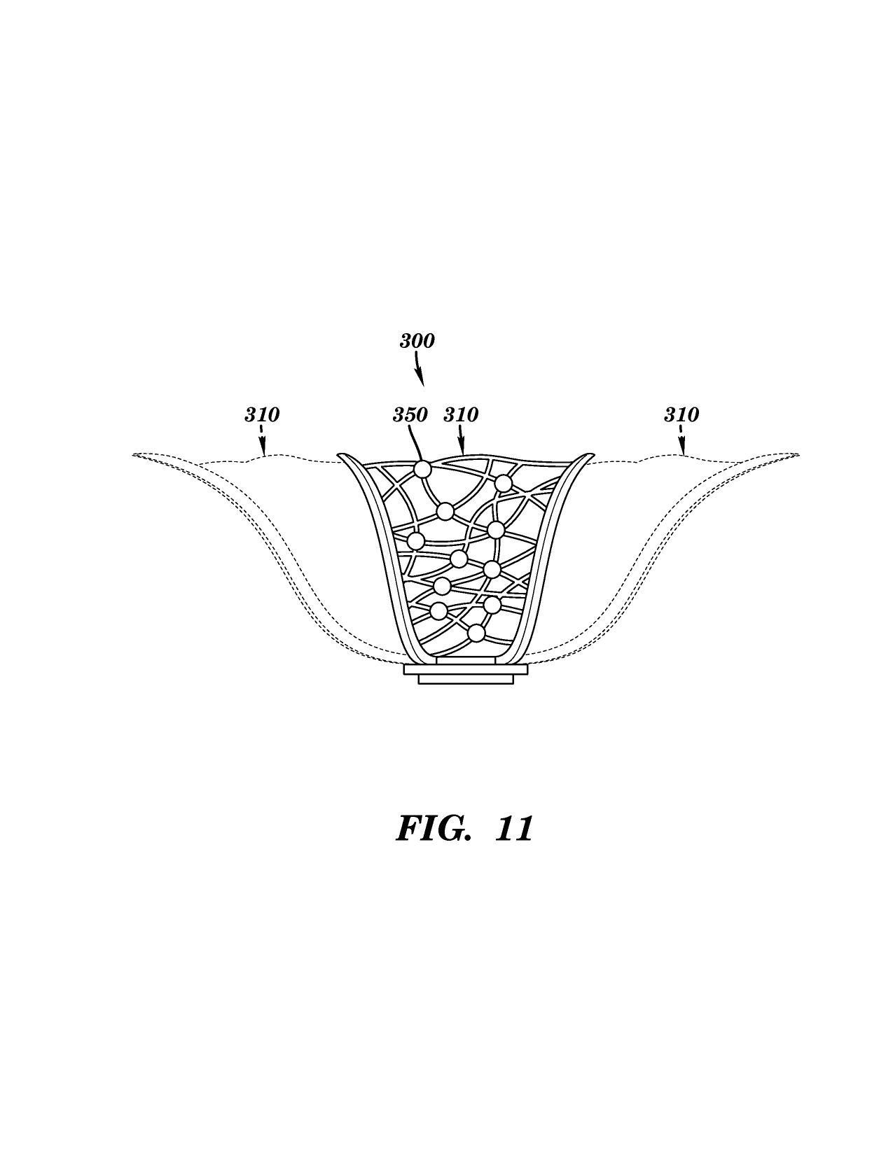

FIG. 11 illustrates another embodiment of a portion 300 of a lighting fixture embodying aspects of the present invention. In this embodiment, a plurality of bendable members 310 may be formed as described above. A plurality of decorative elements 350 such as spheres may be attached to the intersecting portions of the bendable member.

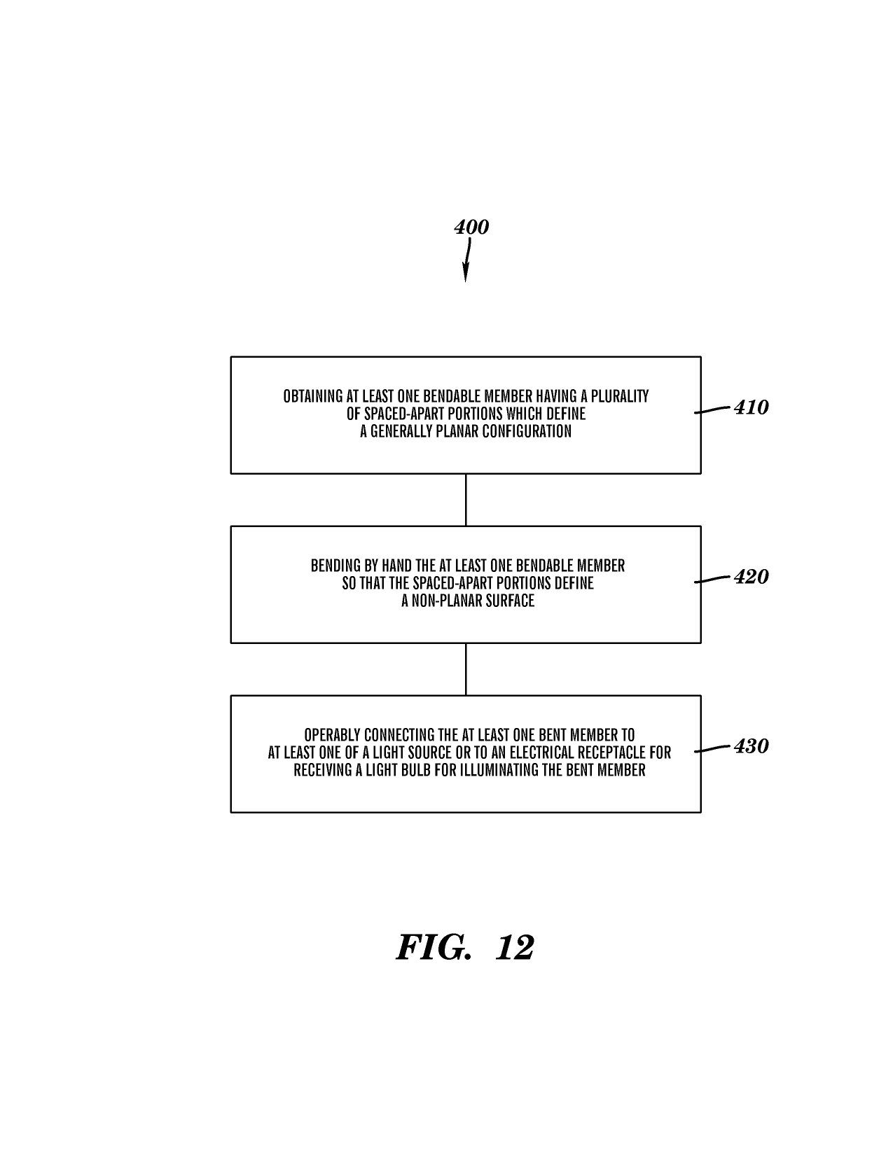

FIG. 12 is a flowchart of a method 400 for forming a lighting fixture. The method may include at 410, obtaining at least one bendable member having a plurality of spaced-apart portions which define a generally planar configuration, and at 420, bending by hand the at least one bendable member so that the spaced-apart portions define a non-planar surface or configuration. The at least one bent member may be operably connected to at least one of a light source or to an electrical receptacle for receiving a light bulb for illuminating the bent member at 430.

Beginning with a solid bendable planar member, the ratio of the remaining portions relative to the cutouts or cutaway portions may be about 10 percent, 20 percent, 30 percent, 40 percent, 50 percent or more, and may range between 10 percent to 90 percent, 20 percent to 80 percent, 30 percent to 70 percent, or other suitable ranges of percentages.

From the present description, it will be appreciated by those skilled in the art, that employing a material having cutouts or removed portions that may be hand formed or bent to a desired contour reduces, if not eliminates, the costs associated with the need for dies, molds, jigs, spinning, and/or 3-dimensional laser cutting, and the associated equipment for forming a portion of lighting fixtures having a desired contoured shape such as a 3-dimensional shape.

While the described lighting fixture of the present invention is illustrated with ornamental vines, it will be appreciated that instead of ornament vines, other representations of recognizable or non-recognizable objects may be employed. While the described lighting fixture employs a plurality of electrical receptacles for receiving light bulbs, it will be appreciated that other lighting sources may be employed such as LEDs. In addition, while the lighting fixture is illustrated as a chandelier, it will be appreciated that the various aspects of the present invention are equally suitable for other types of lighting fixtures. For example, lighting fixtures embodying aspects of the present invasion may include pendent lighting fixtures having a single light source disposed in the middle of the lighting fixture.

Thus, while various embodiments of the present invention have been illustrated and described, it will be appreciated to those skilled in the art that many changes and modifications may be made thereunto without departing from the spirit and scope of the invention.

1. A method for forming a lighting fixture, the method comprising:
obtaining at least one bendable member having a plurality of spaced-apart portions which define a generally planar configuration;
bending by hand the at least one bendable member so that the spaced-apart portions define a non-planar surface; and
operably connecting the at least one bent member to at least one of a light source or to an electrical receptacle for receiving a light bulb for illuminating the bent member.

2. The method of claim 1 wherein the at least one bendable member defines a generally elongated planar configuration.

3. The method of claim 1 wherein the at least one bendable member defines a generally triangular-shaped planar configuration.

4. The method of claim 1 wherein the bending comprises bending the at least one bendable member by hand so that the plurality of spaced-apart portions define a generally smooth contoured surface.

5. The method of claim 1 wherein the bending comprises bending the at least one bendable member by hand so that the plurality of spaced-apart portions define a surface having a contour in at least two directions.

6. The method of claim 1 wherein the bending comprises bending the at least one bendable member by hand so that the plurality of spaced-apart portions define a surface having a contour in an X direction, a Y direction, and a Z direction.

7. The method of claim 1 wherein the bendable member comprises metal.

8. The method of claim 1 wherein the metal comprises steel.

9. The method of claim 1 wherein the obtaining comprises obtaining the at least one bendable member and cutting the at least one bendable member to form the plurality of spaced-apart portions.

10. The method of claim 1 wherein the obtaining comprises obtaining the at least one bendable member having a plurality of decorative elements attached to some of the plurality of spaced-apart portions, and the bending comprises bending the at least one bendable member with the decorative elements.

11. The method of claim 10 wherein the decorative elements comprises at least one of beads and crystals.

12. The method of claim 1 wherein the obtaining the at least one bendable member comprises obtaining a plurality of bendable members each of which having the plurality of spaced-apart portions which define the generally planar configuration, the bending comprises bending by hand each of the bendable members so that the spaced-apart portions define non-planar surfaces, and the operably connecting comprises operably connecting the plurality of bent members around an axis of the lighting fixture.

13. The method of claim 12 wherein the plurality of bent members define a generally bowl-shaped configuration.

14. The method of claim 1 wherein the at least one bent member comprises an elongated member suspendable between a first end of the elongated member and a second end of the elongated member.

15. The method of claim 1 wherein the plurality of spaced-apart portions comprise a representation of a recognizable object.

16. The method of claim 15 wherein the recognizable object comprises at least one vine comprising at least one elongated stem with leaves.

17. The method of claim 16 wherein the at least one elongated stem comprises a portion of the elongated stem that divides into at least two portions and comprising a post therebetween for supporting a decorative element.

18. The method of claim 16 wherein the at least one vine comprises a plurality of branches extending from the at least one elongated stem for supporting a plurality of decorative elements.

19. A lighting fixture comprising:
at least one bent member having a plurality of spaced-apart portions defining a non-planar surface, said at least one bent member formed by hand from a member having a plurality of spaced-apart portions defining a planar configuration; and
at least one light source or electrical receptacle for receiving a light bulb for illuminating said at least one bent member.

20. The lighting fixture of claim 19 wherein said at least one bendable member defines a generally elongated planar configuration.

21. The lighting fixture of claim 19 wherein the at least one bendable member defines a generally triangular-shaped planar configuration.

22. The lighting fixture of claim 19 wherein said at least one bent member having said plurality of spaced-apart portions defines a generally smooth contoured surface.

23. The lighting fixture of claim 19 wherein said at least one bent member having said plurality of spaced-apart portions defines a surface having a contour in at least two directions.

24. The lighting fixture of claim 19 wherein said at least one bent member having said plurality of spaced-apart portions defines a surface having a contour in an X direction, a Y direction, and a Z direction.

25. The lighting fixture of claim 19 wherein said at least one bent member comprises metal.

26. The lighting fixture of claim 25 wherein said metal comprises steel.

27. The lighting fixture of claim 19 wherein said at least one bent member comprises a plurality of decorative elements attached to said plurality of spaced-apart portions.

28. The lighting fixture of claim 27 wherein said decorative elements comprises at least one of beads and crystals.

29. The lighting fixture of claim 19 wherein said at least one bent member comprises a plurality of bent members having a plurality of spaced-apart portions defining non-planar surfaces, each of said plurality of bent members formed by hand from a plurality of members having spaced-apart portions defining planar configurations, and said plurality of bent members operably connected around an axis of said lighting fixture.

30. The lighting fixture of claim 29 wherein said plurality of bent members define a generally bowl-shaped configuration.

31. The lighting fixture of claim 19 wherein said at least one bent member comprises an elongated member suspendable between a first end of said elongated member and a second end of said elongated member.

32. The lighting fixture of claim 19 wherein said plurality of spaced-apart portions comprise a representation of a recognizable object.

33. The lighting fixture of claim 32 wherein said recognizable object comprises at least one vine comprising at least one elongated stem with leaves.

34. The lighting fixture of claim 33 wherein said at least one elongated stem comprises a portion of said elongated stem that divides into at least two portions and comprising a post therebetween for supporting a decorative element.

35. The lighting fixture of claim 33 wherein said at least one vine comprises a plurality of branches extending from said elongated stem for supporting a plurality of decorative elements.

36. An ornamental vine for a lighting fixture, said ornamental vine comprising:
at least one elongated stem and a plurality of leaves extending from said at least one elongated stem; and
a plurality of decorative elements attached to at least some of said leaves and to said stem.

37. The ornamental vine of claim 36 wherein said plurality of decorative elements is attached to some of said leaves and to said stem.

38. The ornamental vine of claim 37 further comprising a plurality of branches extending from said stem and wherein a plurality of decorative elements attach to said plurality of branches.

39. The ornamental vine of claim 36 further comprising a plurality of branches extending from said stem and wherein a plurality of decorative elements attach to said plurality of branches.

40. The ornamental vine of claim 36 wherein said at least one elongated stem comprises a portion of said elongated stem that divides into said at least two portions and wherein one of said decorative element is disposed between said divided portions of said stem.

41. The ornamental vine of claim 40 further comprising at least one additional stem extending from at least one of said stem and said divided portions of said stem, said at least one additional stem comprising a plurality of leaves.

42. The ornamental vine of claim 36 further comprising a plurality of branches extending from said stem, and wherein a portion of said plurality of branch divides into at least two portions and wherein a decorative element is disposed between said divided portions of said branch.

43. The ornamental vine of claim 36 wherein said decorative element comprises at least one of a bead and a crystal.

44. The ornamental vine of claim 36 wherein said at least one elongated stem and said plurality of leaves comprise metal.

45. The ornamental vine of claim 36 wherein at least some of said leaves of said vines comprises decorative elements having a peripheral outline generally corresponding to a peripheral edge of said leaves.

46. The ornamental vine of claim 36 wherein at least some of said leaves of said vines comprises a generally planar shape and said decorative element being attached to a surface of said planar shaped leaf.

47. The ornamental vine of claim 36 wherein said at least one elongated stem comprises a plurality of elongated stems having said plurality of leaves extending from said plurality of elongated stems; and
a plurality of decorative elements attached to at least some of said leaves and to said plurality of elongated stems.

48. The ornamental vine of claim 47 further comprising a plurality of branches extend from said plurality of elongated stems and wherein a plurality of decorative elements attach to said branches.

49. A lighting fixture comprising:
a plurality of ornamental vines of claim 36; and
at least one light source or electrical receptacle for receiving a light bulb for illuminating said plurality of ornamental vines.

50. The lighting fixture of claim 49 wherein said plurality of ornamental vines define bowl shaped configuration.

51. The lighting fixture of claim 50 wherein said elongated stems of said plurality of ornamental vines are generally disposed on an angle around a center axis of said lighting fixture.

52. The lighting fixture of claim 50 wherein said plurality of ornamental vines are suspended at one end adjacent to a center axis of said lighting fixture and at a second end spaced from said center axis of said lighting fixture.

53. The lighting fixture of claim 52 wherein said plurality of ornamental vines is disposed on an angle around said center axis of said lighting fixture.

54. The lighting fixture of claim 49 further comprising a plurality of arms extending radially outward from a center axis of said lighting fixture, and wherein said at least one light source or said electrical receptacle comprise a plurality of light sources or electrical receptacles attached to distal end portions of said plurality of arms.

55. The lighting fixture of claim 54 wherein said plurality of ornamental vines define bowl shaped configuration disposed below said plurality of arms.

56. The lighting fixture of claim 55 wherein said stems of said plurality of ornamental vines defining said surface of said bowl are generally disposed on an angle around said center axis of said lighting fixture.

57. The lighting fixture of claim 54 further comprising a support disposed along said center axis of said lighting fixture, and wherein said stems of said plurality of ornamental vines span between said support and said arms.

58. The lighting fixture of claim 57 wherein said stems of said plurality of ornamental vines spanning between said arms and said support are disposed on an angle around said center axis of said lighting fixture.
